(19) United States
(12) Patent Application Publication
(10) Pub. No.: US 2002/0061767 A1
(43) Pub. Date: May 23, 2002

(54) Mobile imaging

(76) Inventors: Peter Sladen, Winchester (GB); Stephen J. Arnold, Yateley (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/986,576

(22) Filed: Nov. 9, 2001

(30) Foreign Application Priority Data
Nov. 10, 2000 (GB) 0027544.6

(51) Int. Cl. H04M 1/00

(52) U.S. Cl. 455/556; 455/566

(57) ABSTRACT

This invention provided a mobile phone having a camera module (262) which is provided with a mirror (2020) that is pivotally or slidably mounted in relation to the camera so that flipping or sliding of the mirror relative to the camera (202) provides a range of images to the camera. Movement of the camera to take a plurality of images is thus unnecessary.

### BACKGROUND OF THE INVENTION

The present invention relates to imaging and in particular to mobile imaging in a portable radio communication device.

Use of personal computers, in particular laptops, and personal communication devices, such as mobile phones is now commonplace. In connection with such devices, a growing technology is that of digital imaging, and laptops and mobile phones are currently emerging with imaging devices such as cameras and scanners so as to support services such as video telephony and multimedia applications. It is envisaged that video cameras could be connected up with laptops and mobile phones as either integral parts thereof, thus making up part of the electronic apparatus as a whole, or as add-on peripheral devices provided in the form of detachably connectable modular accessories.

Furthermore, it has been noted that rather than arrange the video camera in a fixed relationship with the main device (e.g. laptop/mobile phone), it would be beneficial if the camera were able to adopt a range of positions in relation to the main device. That is, it would significantly increase the usefulness of the camera unit, and thus the apparatus as a whole, if whilst continuing to be electronically connected to the laptop/mobile phone the camera unit was able to be moved about independently of the laptop. In particular, with a laptop/mobile phone equipped with a camera, there are two characteristic modes of operation, 1. video conferencing, that is when the camera is facing the user, and 2. scenic video/photography, that is when the camera is facing away from the user. Thus, there is a need for there to be a degree of relative movement between the camera and the main device.

There are products already available which combine a video camera unit with a laptop computer. In these products, the double requirement for video conferencing and scenic photography has been met by providing a pivot for the camera such that the camera can rotate between the two modes of operation.

In a known laptop computer, the video camera is mounted such that it is capable of turning with respect to the main body of the laptop, i.e. rotationally mounted. So whilst the laptop itself remains relatively static, the video camera may be rotated about the pivot axis. FIG. 1 schematically illustrates the connecting wire and pivot arrangement used in the video camera module of this particular product. As illustrated, the camera module comprises a video camera 2 disposed centrally in a housing 4, a pivot mechanism 6 being provided at one end of the camera housing 4 and a collection of wires 8 extending from the other end of the housing. The pivot mechanism 6 is a relatively large and solid mechanism that effectively supports the camera module in a cantilever fashion in relation to the main body of the laptop. The mechanism consists of a small framework (to the left of the figure) that is secured to the main body of the laptop and a central spindle extending therefrom and terminating in a pressed sheet metal flat portion which is screwed down in the camera module. In terms of electrical connections, the arrangement used in this particular device is to connect the video camera to the laptop by a series of separate wired connections between the video camera unit and a PCB provided in the laptop. As can be seen, there are a number of individual wired connections intertwined with one another along their lengths. The wired connections are loose and provided with a sufficient amount of slack so as to allow pivoting of the video camera unit about the axes of the wires. Each wired connection is soldered at each end to contact points on the video camera unit and the PCB. Whilst this arrangement of separate wired connections is perfunctory in allowing pivotal electrical connection between the video camera unit and the laptop it suffers a number of problems. The wires move in a tortional twisting action about their respective axes and are therefore prone to stretching which may lead to the introduction of errors in the video pictures transmitted between the video camera and the laptop. Also chaffing of the wires is experienced because they tend to rub against one another during movement of the video camera unit. Furthermore, through constant pivoting of the camera, there is a serious risk that the wires will be pulled away from their soldered end connections, or may fracture.

### SUMMARY OF THE INVENTION

Against this background, the present invention provides a portable radio communication device including a camera and having reflection means associated therewith, the reflection means being mounted with respect to the camera such that movement of the reflection means with respect to the camera provides the camera with a plurality of images.

In a preferred arrangement, the reflection means comprises a mirror that is rotatably mounted between first and second positions with respect to the camera, the arrangement being such that in the first position the camera is operable in video conferencing mode, and in the second position the camera is operable in a scenic photographic mode.

An advantage of this invention is that because it is through the movement of the reflection means that provides for the range of images for capture by the camera, such as video conferencing or scenic photography, the camera itself does not move in relation to the base device and therefore there is no moving electronics as such. This leads to higher reliability. Furthermore, the arrangement proposed in the present invention is more space efficient than prior art solutions, and it is found that in comparison to the prior art, the design of the invention is low cost, has high flexibility, high durability and high reliability. It is easier to manufacture than the hard-wired arrangement of the prior art, which is by its nature awkward. In the prior art, the video camera would require several electrical input and output connections, perhaps as many as ten. This many connections making up a pivot constituted by a series of simple wires is bulky and prone to wear. The present invention by comparison is neat, compact and robust. In particular, in comparison to the prior art solution the arrangement of the present invention allows for minituration of the device as a whole, as it substantially removes the space required to accommodate the bulky hinge of the prior art solution along with the space required for the flexible cabling.

### BRIEF DESCRIPTION OF THE DRAWINGS

Other preferred features of the invention and their respective advantages will be understood from the description below of the various embodiments of the invention. Such embodiments are given merely as examples of specific ways of putting the invention into effect, and are described with reference to the accompanying drawings in which:

FIG. 1 is an illustration of a prior art hinge arrangement;

FIG. 2 is a schematic representation of a first embodiment of the invention in a first orientation;

FIG. 3 is a schematic representation of the embodiment of FIG. 2 in a second orientation;

FIG. 4 is a variation of the embodiment shown in FIGS. 2 and 3; and

FIG. 5 is a second variation of the embodiment of FIGS. 1 and 2 in a stowed condition;

FIG. 6 shows the embodiment of FIG. 5 in a deployed condition;

FIG. 7 is a schematic representation of a second embodiment of the invention;

FIG. 8 is an illustration of a component of the embodiment of FIG. 7;

FIG. 9 is an illustration of one arrangement for the mirror component of the embodiment FIG. 7;

FIG. 10 is a second arrangement for the mirror of the embodiment of FIG. 7;

FIG. 11 is an enlarged view of the mirror of FIG. 9;

FIG. 12 is a third arrangement for the mirror of the embodiment of FIG. 7;

FIG. 13 illustrates an implementation of the mirror component of FIG. 12;

FIG. 14 is a schematic representation of the third embodiment of the invention;

FIG. 15 is an enlarged view of the embodiment of FIG. 14;

FIG. 16 shows the variation of the embodiment of FIG. 14 in a stowed condition; and

FIG. 17 shows the variation of the embodiment of FIG. 14 in a deployed condition.

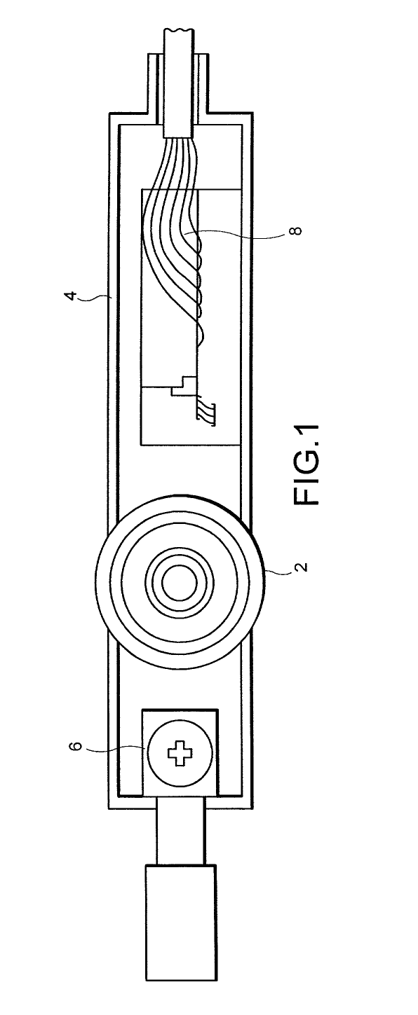

### DETAILED DESCRIPTION OF THE INVENTION

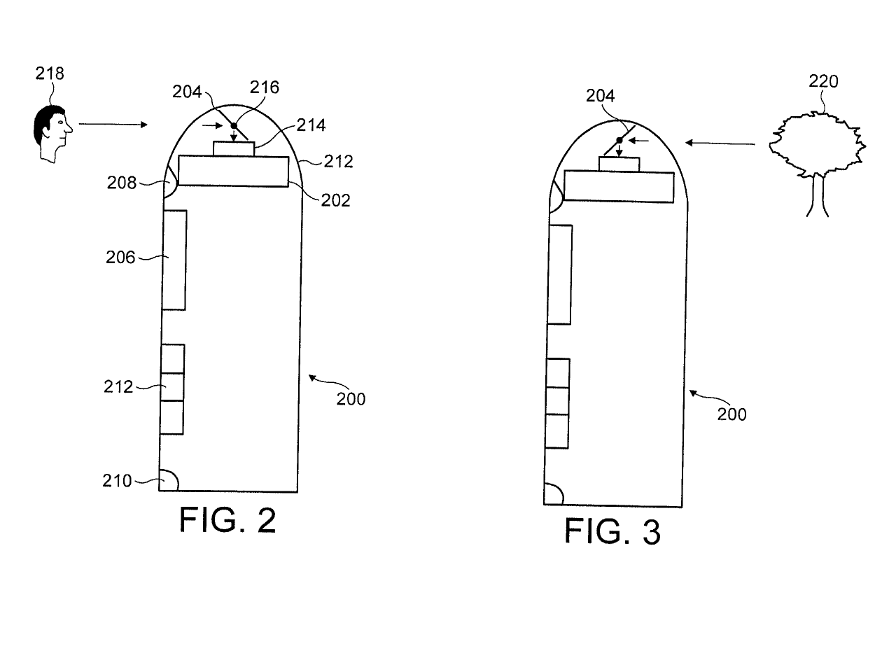

A first embodiment of the invention is depicted schematically in FIG. 2 in side view, and comprises a portable radio communication device, in the form of a mobile phone (200), carrying at its upper end an image capturing means in the form of a digital video camera (202), and supported in a spaced relationship with the video camera is an reflection means in the form of a mirror (204). The mobile phone (200) is equipped with the usual features of a display (206), earpiece (208), microphone (210) and keypad (212). The mobile phone cover in the region of the mirror (204), which in the illustration takes a dome-like configuration, is indicated at 212 and is made of a see-through material such as transparent plastics. The video camera (202) is arranged in a fixed positional relationship with the mobile phone (200) in so much as its relative orientation is fixed, although the camera unit itself may be provided integrally, as in the embodiment shown, or as an add-on accessory. The camera (202) is appropriately connected to transfer image signals to the mobile phone (200). The camera, and more specifically its camera lens (214) points in an upwards direction and the mirror (204) is mounted above the lens (214) in a generally opposing manner as is apparent from FIG. 2. The mirror (204) is rotatably mounted in the structure of this embodiment, in such a manner that it may be rotated, pivoted or flipped with respect to the video camera (202) (and hence the mobile phone). The rotatable mounting is indicated in FIG. 2 by reference 216 and supports the mirror (204) about its central axis in the plane of the mirror. In the configuration shown in FIG. 2, the mirror (204) is oriented about the rotatable mounting (216) so that its reflective surface faces a user (218) of the mobile phone so that it directs images to the video camera (202) of the user (218). These images are captured by the video camera (202), processed and transmitted by the mobile phone (200). This is the video conferencing mode of operation.

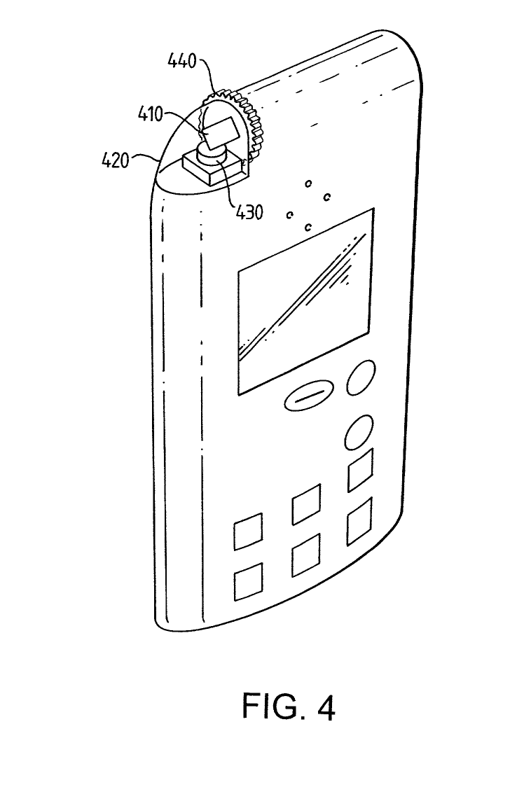

Turning to FIG. 3, this illustrates the embodiment of FIG. 2 in an alternate configuration in which the mirror (204) has been rotated, or ‘flipped’ through 90° about its rotatable mounting (216) in an anti-clockwise direction. Rotation, or ‘flipping’, of the mirror could be performed by any suitable mechanical construction such as a lever, or the like, that is connected to the mirror and provided for that purpose (an example is given in relation to the embodiment of FIG. 4), or by a motorised mechanism. In this configuration, the mirror (204) is oriented so that the reflective surface thereof faces the scenery (220) surrounding the user (218) of the mobile phone such that it provides images to the video camera (202) of the scene (220). The images are captured by the video camera (202) and processed as either still digital photographs or transmitted by the mobile phone (200). This is the scenic photography mode of operation.

FIG. 4 illustrates in a schematic perspective a variation of the first embodiment of the invention in which a mirror (410) to be flipped is mounted on an upper side corner of the mobile phone and is encased in a semi dome-like protective plastic cover (420). The mirror (410) is mounted above a camera (430) on the axis of a knurled wheel (440) that is designed to be user actuable so as to allow the user to flip the mirror between the video conferencing and scenic modes of operation as required.

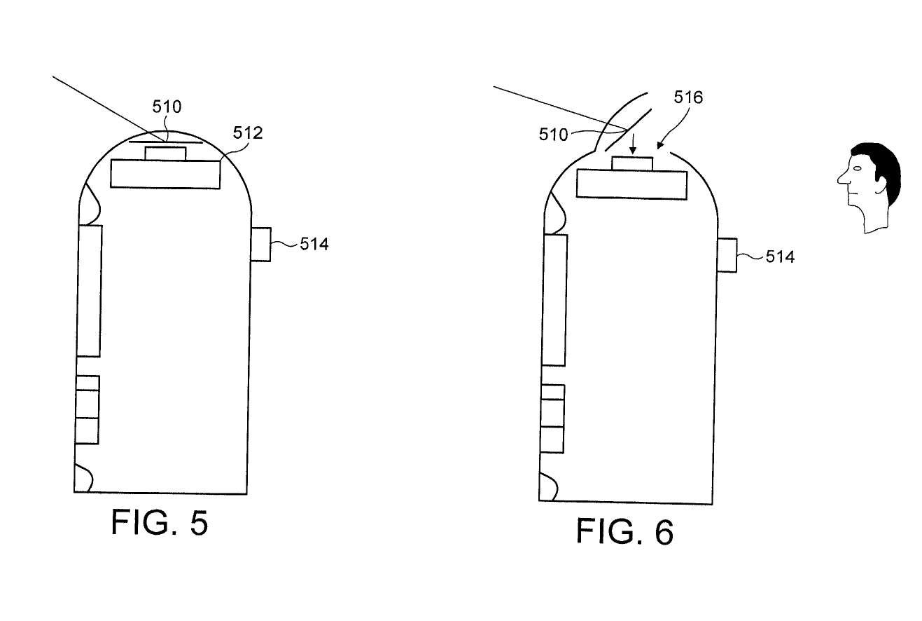

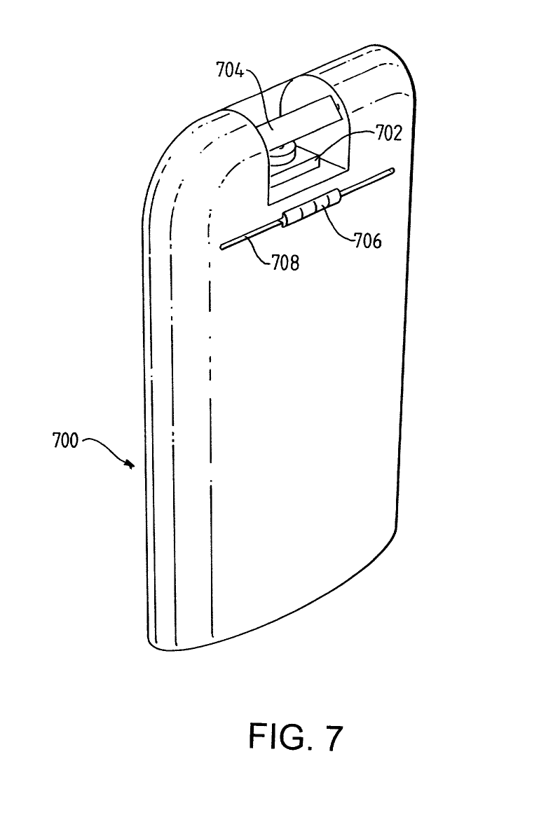

FIGS. 5 and 6 illustrate a second variation of the first embodiment of the invention, and in this variation instead of the mirror being located in the mobile phone housing, the mirror is provided in a pop-up mechanism. In FIG. 5, the mirror (510) is in a stowed condition in which it is folded flat next to a camera (512) in the mobile phone housing. Upon user actuation of for example a button (514) provided on the surface of the mobile phone, the mirror (510) is ejected upwards so that it projects out of the mobile phone housing in its deployed condition. The housing has an opening (516) through which the mirror pops up, and the opening may be normally closed by a hinged lid (518) as depicted in FIG. 6 or a laterally sliding door. Such a pop up mechanism could conveniently be motorised. In its deployed ‘popped-up’ condition the mirror (510) is again rotatably mounted so as to be able to be flipped between video conferencing and scenic modes of operation. The mirror may be returned to its stowed position by depressing the button (514). This provides for a still more compact arrangement.

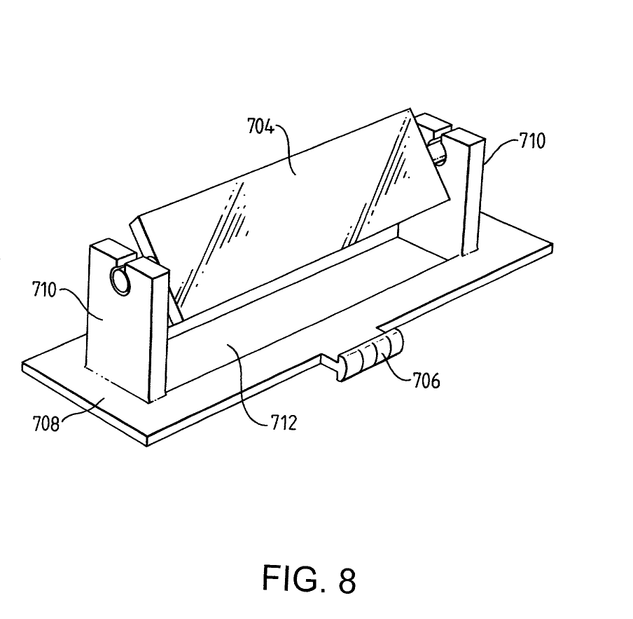

A second embodiment of the invention is illustrated schematically in FIG. 7, and comprises a mobile phone (700) and digital video camera (702) in an equivalent manner to the first embodiment. Again, supported in a spaced relationship with the video camera (702) is an reflection means in the form of a mirror (704). In the structure of this embodiment the mirror (704) is slidably mounted in such a manner that it can be displaced from side to side with respect to the video camera (762) (and hence the mobile phone). As can be seen from FIG. 7, there is a thumb slider (706) that projects out from the mobile phone housing and that can be moved from side to side in a slot (708) provided in the housing. The slider (706) is connected to the mirror (704) so that side to side movement of the slider (706) causes side to side displacement of the mirror (704) relative to the camera (702). FIG. 8 illustrates the structure of the slider (706) in isolation, the arrangement comprises a plate (708) with the thumb slider (706) extending from one of its side edges and a pair of fingers (710) upstanding from the plate (708). Supported between the pair of fingers is the mirror (704). A rectangular opening (712) is provided in the plate and the camera (702) is positioned below the opening (712) with the camera lens pointing upwardly through the opening towards the mirror (704). The mirror (704) is angled downwardly so as to reflect images through the opening and towards the camera lens.

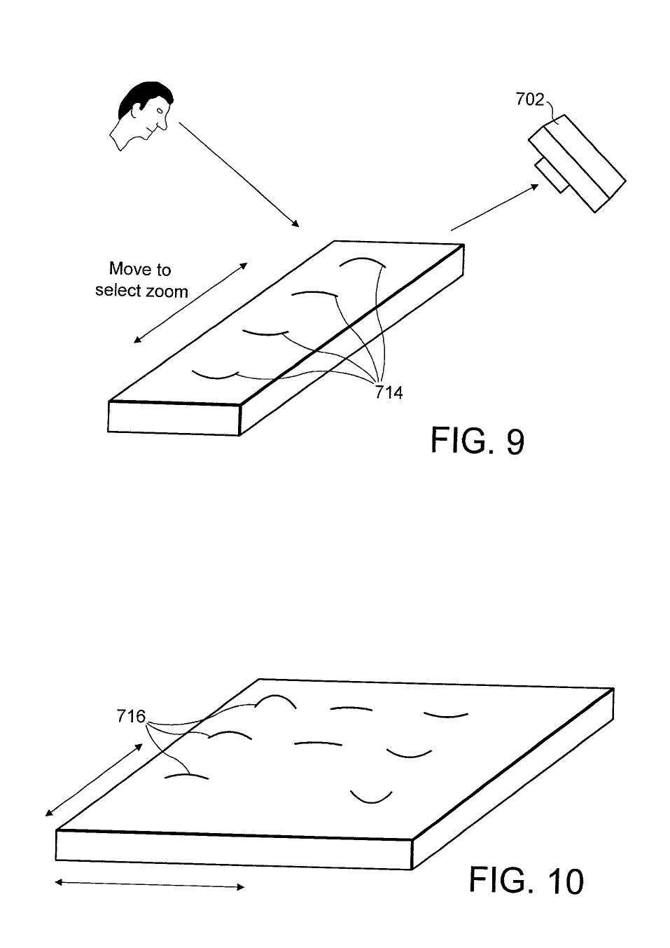

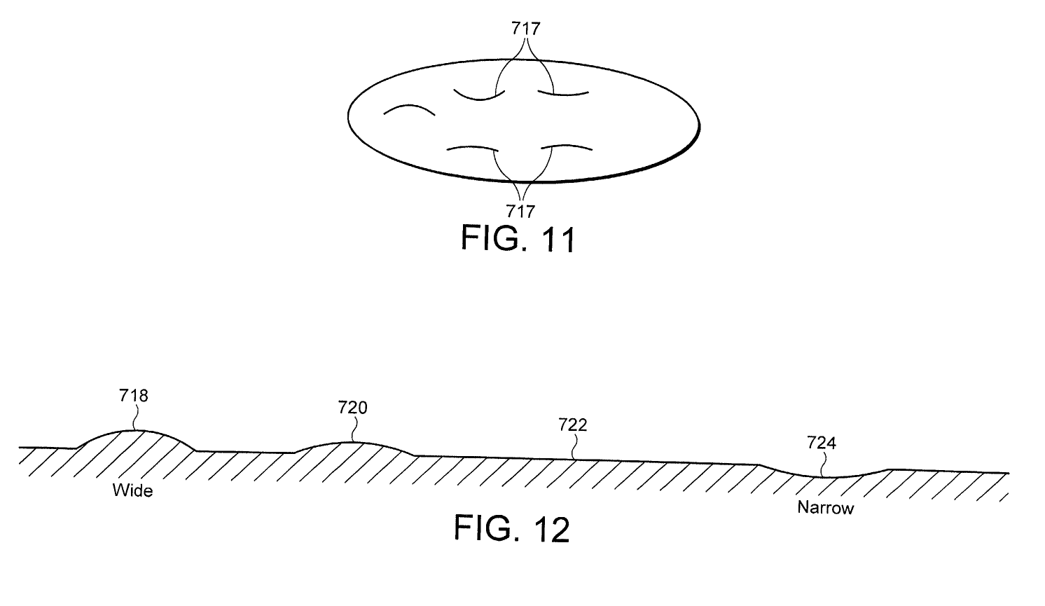

The mirror (704) in this embodiment is provided with an array of mirror elements (714) of different reflecting characteristics. The array of elements may be positioned in a single line as shown in FIG. 9, in a grid-type formation as shown in FIG. 10, or in a circular array as shown in FIG. 11. The mirror (704) is slidably mounted so that each one of the mirror elements (714) is individually selectable such that the selected element can be positioned in relation to the video camera (702) in a way that it directs an image to the camera (702). The selection of different mirror elements each having its own reflecting characteristics allows different images to be provided to the camera. FIG. 12 illustrates in greater detail possible configurations of various mirror elements for the mirror (704). A first mirror element (718) is a wide convex mirror element and is designed to provide a wide viewing angle (and a short focal length). A second mirror element (720) is also a convex mirror element but not as wide as the first mirror element and so gives a less wide viewing angle. A third mirror element (722) is a substantially flat mirror element, and the fourth mirror element (724) is a convex mirror element which provides a narrow viewing angle. It will be appreciated that the mirror elements ranging from first to fourth provide progressively narrower viewing angles having longer focal lengths.

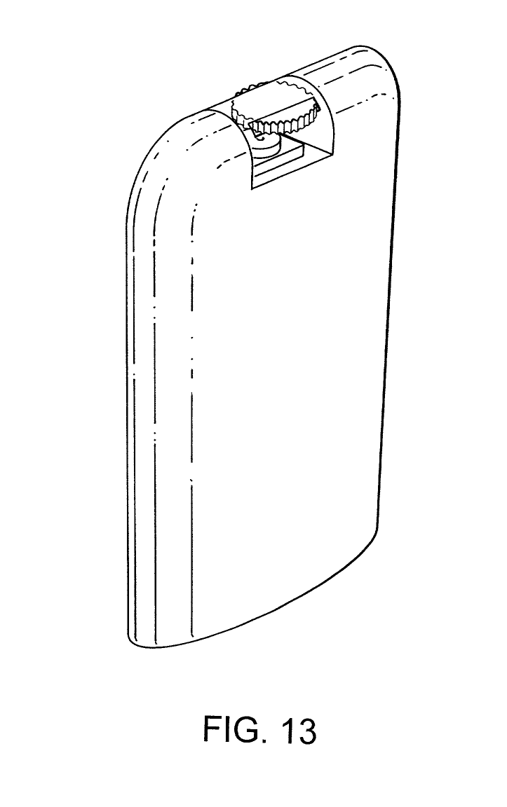

FIG. 10 shows an alternative structure of the mirror, in which the mirror element (716) are provided in a grid formation on a rectangular mirror. The mirror is moved in two dimensions in order to select the appropriate mirror element. FIG. 11 shows a further variation of a mirror in which the mirror elements (717) can be selected by rotating the mirror in relation to the camera as shown in an implementation illustrated in FIG. 13 in which the circular mirror carrying the mirrors element has a knurled edge and is mounted in a rotatable manner in order to provide for the selection of a particular mirror element.

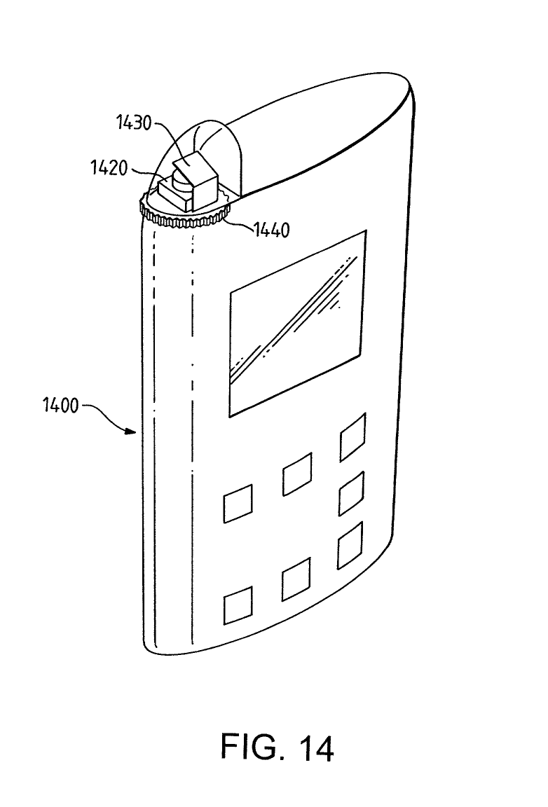

A third embodiment of the invention is illustrated schematically in FIG. 14, and similarly comprises a mobile phone (1400) and digital video camera (1420) in an equivalent manner to the first and second embodiments. The mirror (1430) in this embodiment is rotatably mounted (with reference to the Figure) in the vertical axis in a carousel type arrangement. In this embodiment the mirror is connected to a knurled wheel (1440) that rotates in the horizontal plane about the vertical axis. The camera does not rotate. In this embodiment the mirror (1430) can pan around the phone and direct a full 360° of images around the mobile phone (1400).

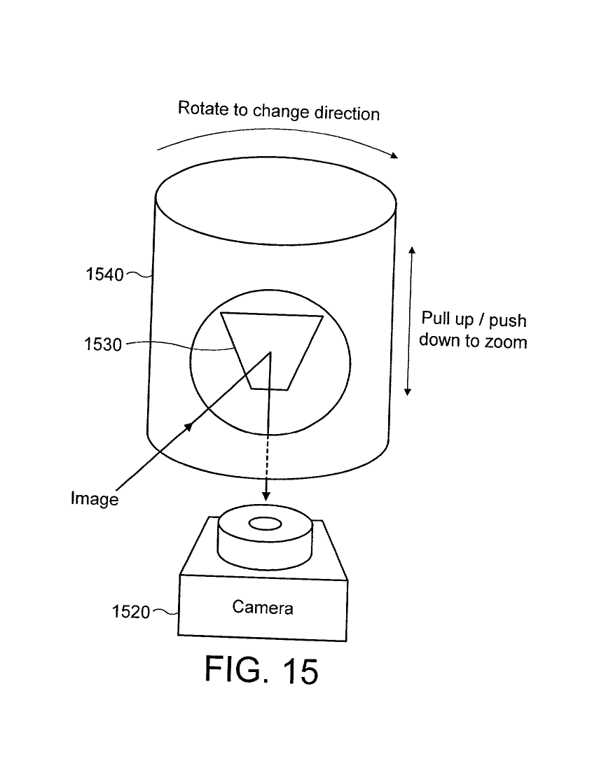

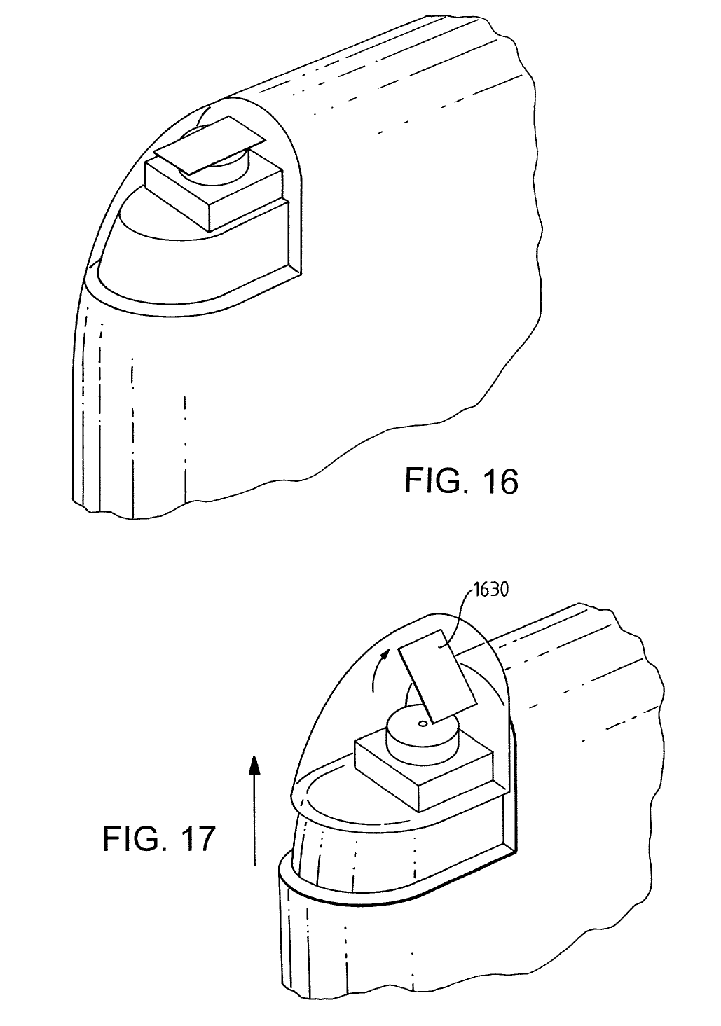

FIG. 15 schematically illustrates a variation of the carousel arrangement in more details and depicts the mirror as a mirror (1530) that is oriented to reflect images downwards to the camera (1520). Rotation of the carousel (1540) causes the rotation of the mirror (1530) to provide a range of different images to the camera (1520).

Furthermore, in this embodiment the carousel (1540) is mounted so that it may be moved linearly up and down with respect to the video camera (1520). Such linear movement affects the level magnification of the image that is directed to the camera (1520), and accordingly provides for zoom functionality.

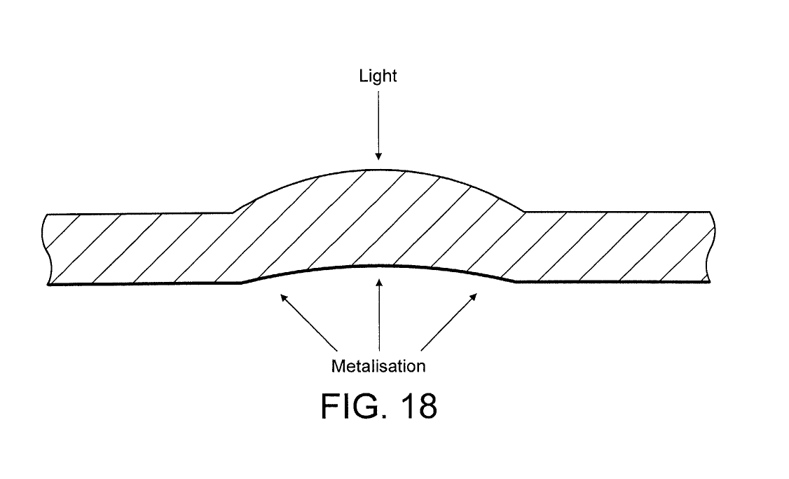

In a variation of this embodiment as illustrated in FIGS. 16 and 17, the camera (1620) and mirror (1630) may be provided in a pop-up mechanism in which the mirror in a stowed condition initially lays flat facing the camera. To use the camera, a button may be pressed and this pushes the camera and mirror up as can be seen in FIG. 17, and the mirror is lifted from the camera so to be ready to be rotated for video conferencing and scenic mode of operation. The mirror (1630) in this variation is also mounted to be vertically slideable in relation to the camera and this may be actuated by further depression of the button. In other words, pressing on alternate buttons moves the mirror (1630) linearly up and down in order to move the mirror (1630) towards and away from the camera (1620). This has the effect of varying the zoom provided to the camera. This may also be provided in a manual mechanism which is actuated by the user who pulls up the camera and mirror module initially to the open position from the closed position, and the user then pulls up the module further to cause the mirror to be moved away from the camera so as to control the zoom. Thus allowing for selectable viewing angles using only a simple fixed focal length mirror.

As will be appreciated by the skilled reader, various forms and types of reflection means may be employed in the present invention. Examples being mirrors, prisms and reflecting lenses.

The present invention may be embodied in other specific forms without departing from its essential attributes. Reference should thus be made to the appended claims and other general statements herein rather than to the foregoing description as indicating the scope of invention.

For example, the mirror may be mounted so as to be a combination of both rotatable and slideable with respect to the camera.

Furthermore, each feature disclosed in this specification (which term includes the claims) and/or shown in the drawings may be incorporated in the invention independently of other disclosed and/or illustrated features. In this regard, the invention includes any novel feature or combination of features disclosed herein either explicitly or any generalisation thereof irrespective of whether or not it relates to the claimed invention or mitigates any or all of the problems addressed.

The appended abstract as filed herewith is included in the specification by reference.

What is claimed is:

1. A portable radio communication device including a camera and having reflection means associated therewith, the reflection means being mounted with respect to the camera such that movement of the reflection means with respect to the camera provides the camera with a plurality of images.

2. A portable radio communication device according to claim 1, wherein the reflection means comprises a mirror rotatably mounted between first and second positions with respect to the camera, the arrangement being such that in the first position the camera is operable in video conferencing mode, and in the second position the camera is operable in a scenic photographic mode.

3. A portable radio communication device according to claim 2, wherein the reflection means is connected to a user actuable controller adapted for movement between said first and second positions.

4. A portable radio communication device according to claim 1, wherein the reflection means and the camera are mounted for displacement between a stowed condition in which the reflection means and the camera are located within the housing of the portable radio communication device, and a deployed condition in which the reflection means and the camera are projected beyond the housing of the portable radio communication device.

5. A portable radio communication device according to claim 4, wherein the reflection means and the camera are moved between the stowed and deployed conditions by a button.

6. A portable radio communication device according to claim 1, wherein the reflection means comprises a mirror slidably mounted with respect to the camera, the mirror including a plurality of mirror elements, each of said mirror elements being individually selectable for cooperation with said camera by sliding said mirror.

7. A portable radio communication device according to claim 1, wherein the reflection means comprises a mirror slidably mounted with respect to the camera, the arrangement being such that sliding movement of the reflection means controls zoom selection for the camera.

8. A reflection means and camera module for use in a portable radio communication device as defined in any preceding claim.
